(19) United States
(12) Patent Application Publication
(10) Pub. No.: US 2025/0258323 A1
(43) Pub. Date: Aug. 14, 2025

(54) DIELECTROWETTING-BASED LIQUID LENS

(71) Applicant: CORNING INCORPORATED, CORNING, NY (US)

(72) Inventor: Benjamin Jean-Baptiste Francois Burger, Lyon (FR)

(21) Appl. No.: 18/704,821

(22) PCT Filed: Oct. 24, 2022
(86) PCT No.: PCT/US2022/047557

§ 371 Date: Apr. 25, 2024

Related U.S. Application Data
(60) Provisional application No. 63/272,392, filed on Oct. 27, 2021.

(51) Int. Cl. G02B 3/14; G02B 26/00

(52) U.S. Cl. CPC G02B 3/14; G02B 26/004

(57) ABSTRACT

A liquid lens includes a cavity, and a first liquid and a second liquid disposed in the cavity. The first liquid differs from the second liquid. A variable interface is defined between the first and second liquids. The liquid lens includes an interdigitated array of electrode segments including a plurality of driving electrode segments interdigitated with a plurality of common electrode segments disposed on an inclined sidewall portion of the cavity. An insulating layer isolates each of the plurality of common electrode segments and at least one of the plurality of driving electrode segments from both the first and second liquids. An interface between the liquids and a surface of the liquid lens is adjustable so as to change a focus of the liquid lens by adjusting polarity of the first and second liquids.

### RELATED APPLICATIONS

This is a U.S. National Stage application under 35 U.S.C. § 371 of International Patent Application No. PCT/US2022/047557, filed Oct. 24, 2022, which claims priority to U.S. Provisional Application 63/272,392, filed Oct. 27, 2021, the entirety of which is incorporated herein by reference.

### FIELD

This disclosure relates to variable lenses, and more particularly, to liquid lens devices, systems and methods relating to manufacture of liquid lenses.

### BACKGROUND

Liquid lenses generally include two immiscible liquids in a chamber. Controlling the electric field to which the liquids are subjected varies the shape of the meniscus formed between the two liquids. Changing the curvature of the meniscus is achieved by changing the wetting properties of liquid droplets, for example, using electrowetting.

### SUMMARY

Disclosed herein are liquid lens devices and methods relating to manufacture of liquid lenses.

Disclosed herein is a liquid lens including a cavity, a first liquid disposed in the cavity and a second liquid disposed in the cavity. The first and second liquids are immiscible. The liquid lens further includes an interdigitated array of electrodes comprising a plurality of driving electrode segments interdigitated with a plurality of common electrode segments disposed on an inclined sidewall portion of the cavity. The liquid lens further includes an insulating layer structured to isolate each of the plurality of common electrode segments and the plurality of driving electrode segments from both the first and second liquids. An interface between the liquids and a surface of the liquid lens is adjustable so as to change a focus of the liquid lens by adjusting polarity of the first and second liquids.

Disclosed herein is a liquid lens including a cavity configured to house dielectric liquid, and an interdigitated array of electrodes comprising at least one first electrode interdigitated with at least one second electrode placed on an inclined sidewall portion of the cavity. The liquid lens includes an insulating layer isolating each of the at least one first electrode and the at least one second electrode from the liquid, and electrode leads for the array of electrodes being disposed on one side of a first window above the cavity or one side of a second window below the cavity.

Disclosed herein is a method of making a liquid lens, including depositing a plurality of microelectrodes in an array on a sidewall portion of a cavity of a lens body, the sidewall portion of the cavity inclined such that a cross-sectional area of the cavity decreases in a direction from an object side of a lens body to an image side of the lens body. The plurality of microelectrodes comprise a plurality of driving electrode segments interdigitated with a plurality of common electrode segments. The method includes depositing an insulating layer on the at least one of the plurality of driving electrode segments; and depositing a first liquid and a second liquid in the cavity, the insulating layer isolating at least one of the driving electrode segments from each of the first liquid and the second liquid.

It is to be understood that the foregoing description and the following description are merely exemplary, and are intended to provide an overview or framework to understanding the claimed subject matter.

### BRIEF DESCRIPTION OF THE DRAWINGS

The details of one or more embodiments are set forth in the accompanying drawings and the description below. Other features, aspects, and advantages of the disclosure will become apparent from the description, the drawings, and the claims. In the drawings, like reference numerals are used throughout the various views to designate like components.

FIG. 1 is a schematic cross-sectional view of a liquid lens according to at least one embodiment.

FIG. 2A is a top view of a portion of a liquid lens including at least two electrodes according to at least one embodiment.

FIG. 2B is a top view of a portion of a liquid lens including at least eight electrodes according to at least one embodiment.

FIG. 2C is a top view of a portion of a liquid lens including an electrode array according to at least one embodiment.

FIG. 3 is a schematic cross-sectional view of a liquid lens according to at least one embodiment.

FIG. 4 is a diagram depicting a process according to at least one embodiment.

FIG. 5A is a schematic top view of a liquid lens according to at least one embodiment.

FIG. 5B is a cross-sectional view of the liquid lens of FIG. 5A.

FIG. 5C is a detail view of the cross-sectional view shown in FIG. 5B.

FIG. 6 is a graph depicting optical power versus the root mean square voltage of a liquid lens according to at least one embodiment.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The following terms are used throughout and are as defined below.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. The expression “comprising” means “including, but not limited to.” Thus, other non-mentioned substances, additives, carriers, or steps may be present. Unless otherwise specified, “a” or “an” means one or more.

Unless otherwise indicated, all numbers expressing quantities of properties, parameters, conditions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number of reported significant digits and by applying ordinary rounding techniques. The term “about” when used before a numerical designation, e.g., temperature, time, amount, and concentration including range, indicates approximations which may vary by (+) or (−) 10%, 5% or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

### Liquid Lens Devices

Liquid lenses can be configured as electro-optical devices in which a lens effect is provided by a curved interface between a polar electrolyte and an insulating non-polar liquid. The curvature radius of this interface can define the optical power of the lens. Using electrowetting principles, the application of voltage between the electrolyte and an electrode placed under a hydrophobic insulating layer can change the radius of curvature of the meniscus, thereby changing the focal length of the lens. In some liquid lenses, electrowetting on dielectric material is used to vary optical power.

The electrowetting effect can be limited by electrowetting saturation. For example, due to the contact angle saturation, the total range of variation for the radius of curvature of the meniscus is limited, so as to constrain the extent to which the focal length may be varied. Further, electrowetting can involve direct contact between a common electrode and an electrolyte (e.g., a dielectric liquid). In some lenses, the liquid is directly in contact with a conductive layer making up the electrode or other layers, some of which may be made of materials that are sensitive to electric charge or to various chemical substances (e.g., coating layers). Chemical interactions between the electrolyte and such layers may contribute to degradation and reliability failures.

In electrowetting on dielectric material, the dielectric layer can be very thin (e.g., 0.1 to 5 microns). In such devices, dielectric breakdown can be an issue. In contrast, using dielectrowetting, the electric field can be applied to a much larger dielectric thickness, defined by the distance between interdigitated electrodes. In some embodiments, the interelectrode distance may be 20 to 250 microns (e.g., 50 microns).

A significant manufacturing yield loss can be associated with dielectric breakdown of the dielectric layer. Furthermore, when the electrolyte is used for a liquid electrode, dielectric breakdown can occur after lengthy exposure to the electric field. As an example, water treeing at the point of electric stress may occur, leading to a reduction in the effective thickness of the dielectric layer due to partial discharges (which occur in a path resembling the branches of a tree).

Further, the manufacturing processes involved in making electrowetting-based liquid lenses can be complex. In particular, patterning the electrodes for applying the voltage to adjust the lens focus can involve numerous steps such as scribing, masking, unmasking, and so forth. Further still, additional processes can be performed, such as laser trimming, which can be used to expose conductive and dielectric layers and a glass portion of the lens to the electrolyte. An electrolyte composition typically includes water, additives, and ions. The reliability of the liquid lens may be adversely affected due to the sensitivity of one or more of the conductive layer, dielectric layer, or glass to the electrolyte composition.

Dielectrowetting, in contrast, can be based on the principles of liquid dielectrophoresis, a phenomenon in which a force acts on dipoles in a dielectric liquid in a non-uniform electric field, so as to polarize the dielectric liquid. Dielectrowetting can be due to the polarization of dipoles within the liquid. The dipole activity can change the energy balance at an interface between a dielectric liquid and a solid material. Dielectrowetting can allow for reversibly modifying the contact angle of a liquid droplet by applying voltage. The voltage strength can be dependent on the non-uniform field and the properties of the liquid(s).

According to various embodiments disclosed herein, liquid lenses are provided which leverage the above-mentioned principles of dielectrowetting. A liquid lens according to one or more embodiments is formed by a meniscus between two immiscible liquids. In some embodiments, both liquids have a matched density but a different optical index. The immiscible liquids are both dielectric liquids (dielectric material in a liquid state) with significantly different dielectric constants. In some embodiments, a low dielectric liquid is an aliphatic alkane (linear, branched, or cyclic). The dielectric constant range for such liquids can be 1.5 to 3. Additionally, or alternatively, a high dielectric liquid is water, an alcohol, or a polyol. The dielectric constant range for water and short chain alcohols can be 20 to 80. An electric field can be used to change the radius of curvature of the meniscus. In some embodiments, none of the liquids is in contact and/or electrical communication with the common electrode, in contrast to electrowetting-based liquid lenses.

Further, in at least one embodiment, an electric field is generated with an interdigitated array of electrodes. Interdigitated electrodes can be formed in a comb-like network and may be fabricated on thin substrates. Among the array of interdigitated electrodes, one or more driving electrode and a common electrode may be provided. In some embodiments, an electrode array includes a plurality of driving electrode segments interdigitated with a plurality of common electrode segments, as discussed further below. In at least one embodiment, both the driving electrodes and common electrode are insulated from the dielectric liquids through a dielectric layer. In some embodiments, “segment” may refer to a portion of an electrode, a discrete electrode element, an entirety of an electrode, or a plurality of segments.

In various embodiments, a liquid lens comprises a first window. For example, the liquid lens comprises a first substrate comprising the first window and a peripheral portion at least partially circumscribing the first window. In some embodiments, a cavity is disposed between the first substrate and a second window, and a first liquid and a second liquid are housed within the cavity. In some embodiments, the liquid lens comprises a common electrode, a driving electrode, and an insulating layer disposed within the cavity to insulate the driving electrode and the common electrode from each of the first liquid and the second liquid. In some embodiments, multiple driving electrodes or segments thereof may be provided.

In some embodiments, the liquid lens comprises a first liquid disposed within the cavity, a second liquid disposed within the cavity, at least one common electrode segment, at least one driving electrode segment, and an insulating layer disposed on the sidewall of the cavity to insulate the at least one driving electrode segment and the at least one common electrode segment from each of the first liquid and the second liquid. In some embodiments, a peripheral portion of the first substrate is bonded to the second substrate to seal the first liquid and the second liquid stored within the cavity.

The various features described throughout this disclosure can be used individually or in various combinations.

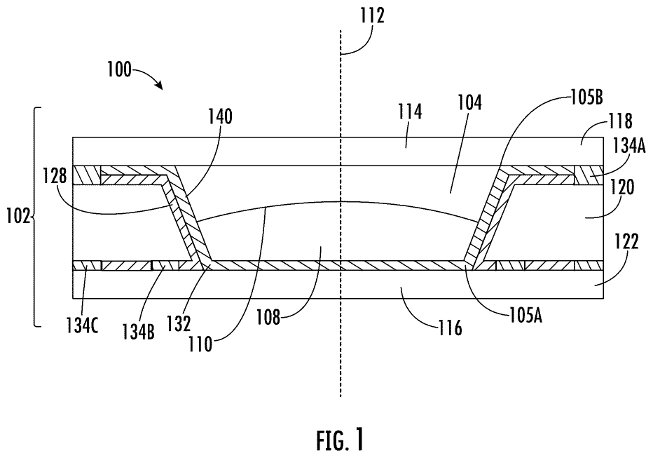

FIG. 1 is a schematic cross-sectional view of some embodiments of a liquid lens 100. In some embodiments, liquid lens 100 comprises a lens body 102 and a cavity 104 formed in the lens body. A first liquid 106 and a second liquid 108 are disposed within cavity 104. In some embodiments, first liquid 106 is a dielectric polar liquid. Additionally, second liquid 108 is a dielectric non-polar liquid (e.g., oil). In some embodiments, first liquid 106 and second liquid 108 are substantially immiscible, whereby an interface 110 is formed between the first liquid and the second liquid.

In some embodiments, first liquid 106 and second liquid 108 have different refractive indices such that interface 110 between the first liquid and the second liquid forms a lens. In some embodiments, the first liquid 106 and the second liquid 108 differ in dielectric constant. In some embodiments, the dielectric constant of the first liquid 106 is 2 to 100 times the dielectric constant of the second liquid 108, and the difference between the dielectric constants ranges from about 10 to 150. In at least one embodiment, the dielectric constant of the first liquid 106 is 5 to 50 times the dielectric constant of the second liquid 108, and the difference between the dielectric constants ranges from about 20 to 80. In at least one embodiment, the first liquid may include a mixture of water and ethylene glycol, which have dielectric constants of 80 and 38, respectively. In at least one embodiment, the second liquid 108 may include a germanium compound having a dielectric constant of between 2-4.

In some embodiments, first liquid 106 and second liquid 108 are in direct contact with each other at interface 110. For example, first liquid 106 and second liquid 108 are substantially immiscible with each other such that the contact surface between the first liquid and the second liquid defines interface 110. In some embodiments, no membrane is present between the first liquid 106 and the second liquid 108.

In some embodiments, cavity 104 is at least partially defined by a bore in an intermediate layer of liquid lens 100 as described herein. Additionally, or alternatively, second liquid 108 is disposed within the bore. In some embodiments, the perimeter of interface 110 (e.g., the edge of the interface in contact with the sidewall of the cavity) is disposed within the bore.

The contact angle of the liquid lens 100 can be adjusted via dielectrowetting as described above, by adjusting the driving voltage applied via the electrodes. The following equation, Equation 1, is a modification of Young's law for dielectrowetting. The contact angle under voltage is given by Equation 1.

Cos θ(V)=cos θ₀+ε₀(εₑ−√ₒ)/2γδV², where Equation 1:
θ₀ is the contact angle without voltage;
ε₀ is the dielectric constant of the vacuum;
εₑ is the dielectric constant of the first liquid;
εₒ is the dielectric constant of the second liquid;
γ is the surface tension between the first and the second liquid; and
δ is the electric field penetration depth into the liquids, which value is defined by the gap between the electrodes and the thickness of the insulating coating.

Controlling the contact angle as described above changes the interface 110 and in turn changes the focal length or focus of liquid lens 100. For example, such a change of focal length may permit liquid lens 100 to perform an autofocus function. Additionally, or alternatively, adjusting interface 110 tilts the interface relative to a structural axis 112 of liquid lens 100 (e.g., to tilt an optical axis of the liquid lens relative to the structural axis of the liquid lens). For example, such tilting can enable liquid lens 100 to perform an optical image stabilization (OIS) function. Adjusting interface 110 can be achieved without physical movement of liquid lens 100 relative to an image sensor, a fixed lens or lens stack, a housing, or other components of a camera module in which the liquid lens can be incorporated.

Following Equation 1 above, the performance of the liquid lens according to one or more embodiments is also dependent on the distance (e.g., the clearance) between the interdigitated electrodes (e.g., the distance between two adjacent electrodes or segments of the electrode array forming an electrode network of interdigitated electrodes). In some embodiments, the distance may be between 10 and 250 microns. In some embodiments, the distance may be between 20 and 100 microns.

In some embodiments, the liquid lens is configured to be actuated under DC power. A potential advantage of DC actuation is very low power consumption. In other embodiments, the liquid lens is configured to be actuated under AC power. Potential advantages of AC actuation include a lower hysteresis, and an improved contact angle stability. In some embodiments, the frequency of the AC driving voltage may be between about 1 kHz and about 10 KHz.

In some embodiments, lens body 102 of liquid lens 100 comprises a first window 114 and a second window 116. In some embodiments, cavity 104 is disposed between first window 114 and second window 116. In some embodiments, lens body 102 comprises a plurality of layers that cooperatively form the lens body. For example, in some embodiments, as shown in FIG. 1, lens body 102 comprises a first outer layer, or first substrate, 118, an intermediate layer, or second substrate, 120, and a second outer layer, or third substrate, 122. In some of such embodiments, intermediate layer 120 comprises a bore formed therethrough. First outer layer 118 can be bonded to one side (e.g., the object side) of intermediate layer 120. For example, first outer layer 118 is bonded to intermediate layer 120 at a bond 134A.

Additionally, or alternatively, second outer layer 122 can be bonded to the other side (e.g., the image side) of intermediate layer 120 (e.g., opposite first outer layer 118). For example, second outer layer 122 is bonded to intermediate layer 120 at a bond 134B and/or a bond 134C. In some embodiments, intermediate layer 120 is disposed between first outer layer 118 and second outer layer 122, the bore in the intermediate layer is covered on opposing sides by the first outer layer and the second outer layer, and at least a portion of cavity 104 is defined within the bore. Thus, a portion of first outer layer 118 covering cavity 104 serves as first window 114, and a portion of second outer layer 122 covering the cavity serves as second window 116.

In some embodiments, cavity 104 is inclined as shown in FIG. 1 such that a cross-sectional area of at least a portion of the cavity decreases along structural axis 112 in a direction from the object side toward the image side. For example, cavity 104 comprises a narrow end 105A and a wide end 105B. The terms “narrow” and “wide” are relative terms, meaning the narrow end is narrower, or has a smaller width or diameter, than the wide end. Such an inclined cavity can have a substantially truncated conical cross-sectional shape (e.g., a frustoconical shape). For example, a sidewall 140 of cavity 104 can have the shape of a frustum of a cone.

Additionally, or alternatively, such an inclined cavity can help to maintain alignment of interface 110 between first liquid 106 and second liquid 108 along structural axis 112; however, the inclination of the cavity 104 may not be needed to achieve centering of the liquid droplets. In some embodiments, cavity 104 is rotationally symmetrical (e.g., about structural axis 112 of liquid lens 100).

In some embodiments, image light enters liquid lens 100 through first window 114, is refracted at interface 110 between first liquid 106 and second liquid 108, and exits the liquid lens through second window 116. In some embodiments, first outer layer 118 and/or second outer layer 122 have sufficient transparency to enable passage of the image light. For example, first outer layer 118 and/or second outer layer 122 comprise a polymeric, glass, ceramic, or glass-ceramic material. In contrast, the surface of the cavity 104 may be substantially opaque, e.g., by being coated with an opaque hydrophobic coating. In some embodiments, the opaque coating may be a black coating.

In some embodiments, outer surfaces of first outer layer 118 and/or second outer layer 122 are substantially planar. Thus, even though liquid lens 100 can function as a lens (e.g., by refracting image light passing through interface 110), outer surfaces of the liquid lens can be flat as opposed to being curved like the outer surfaces of a fixed lens. In some embodiments, intermediate layer 120 may include a metallic, polymeric, glass, ceramic, or glass-ceramic material. Because image light can pass through the bore in intermediate layer 120, the intermediate layer may or may not be transparent. The windows 114, 116 may be transparent in some embodiments. The second layer 122 may be omitted in some embodiments. The bottom window may be integrated into the layer 120, and the lens 100 may be made out of two layers rather than three.

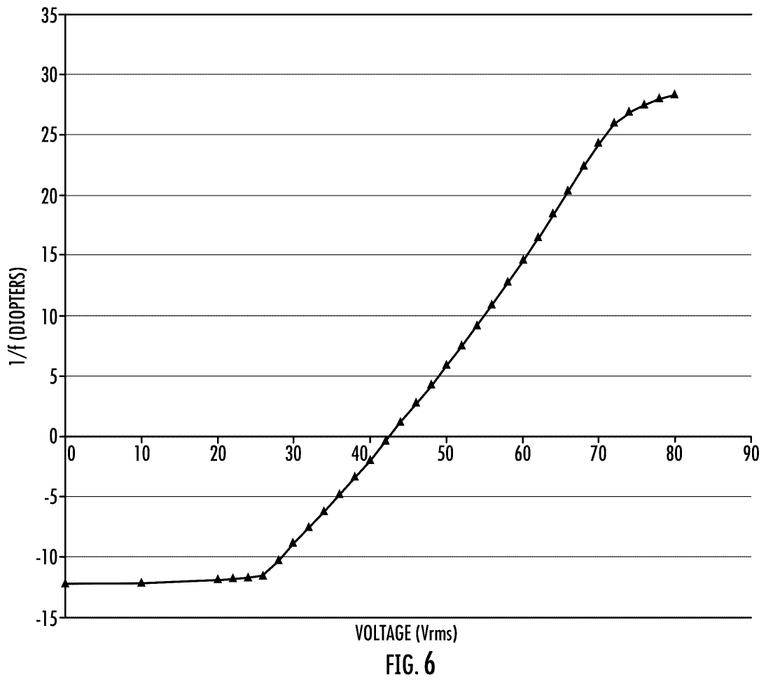

FIG. 6 depicts an exemplary relationship between optical power as measured in diopters (1/focal length f) versus the voltage of a liquid lens with an inclined cavity and using dielectrowetting techniques according to one or more embodiments. For example, the voltage is the potential difference between driving and common electrodes or electrode segments as described herein. An optical power of about 28 diopters may be attained when the root mean square (RMS) of the voltage V is about 80. Negative diopters are realized for RMS voltage values less than about 42. Without an inclined cavity 104, it is expected that the power would be shifted to higher voltage values, such that any optical power obtained would be positive.

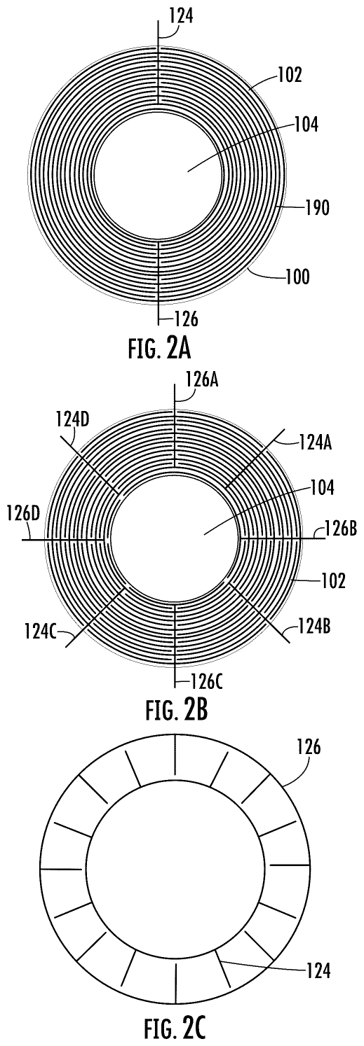

In some embodiments, liquid lens 100 comprises common electrode segments 124 and driving electrode segments 126 that are part of an electrode network 190 shown in FIG. 2A. The electrode network 190 is an interdigitated electrode array made up of common electrode segments 124 and driving electrode segments 126 that extend at least partially around sidewall 140 of cavity 104. In at least one embodiment, the segments are ‘fingers’ that may be arranged in an alternating fashion in a comb-like structure. More particularly, the common electrode segments 124A, 124B, 124C and 124D and the driving electrode segments 126A, 126B, 126C and 126D make up the electrode network 190. Further, in at least one embodiment, the electrode segments may be arranged concentrically, and the concentric arrangement of the electrode segments—rather than or in addition to the inclination of the cavity 104—is conducive to centering of droplets of liquid 106, 108 in the cavity 104.

The electrode network 190 of liquid lens 100 may include, in some embodiments, the driving electrode 126A as a first driving electrode which is disposed on a sidewall of cavity 104 and insulated from first liquid 106 and second liquid 108. The common electrode 124 and driving electrode 126 generate an electric field to vary the radius of curvature of the meniscus. In some embodiments, electrode leads for the array of electrodes of the electrode network 190 are disposed on only one of opposed first and second surfaces of the intermediate layer 120. In some embodiments, the leads may be disposed only on a first side of the cavity 104.

In the annular arrangement shown in FIG. 2C, no electrical ‘shortcuts’ are present between the driving electrodes 126A-D and the common electrode 124. The electrode network 190 shown in FIG. 2C may be disposed on or extend onto an upper surface of a portion of a lens body 102 above the cavity 104. Further, in some embodiments, the electrode network 190 may be arranged around the opening of cavity 104, as shown in FIG. 2C. In particular, the segments of the common electrode 124 and driving electrode segments 126A-D may be configured with an arcuate shape extending partially around sidewall portion 140 of cavity 104. The interdigitated electrodes of the electrode network 190 are microelectrodes that may be disposed in a radial or a concentric circular distribution on an upper surface of the first outer layer 118.

In some embodiments, liquid lens 100 comprises a conductive layer 128, at least a portion of which is disposed within cavity 104 and/or defines at least a portion of the sidewall of the cavity. For example, conductive layer 128 comprises a conductive coating applied to intermediate layer 120 prior to bonding first outer layer 118 and/or second outer layer 122 to the intermediate layer. Conductive layer 128 can comprise a metallic material, a conductive polymer material, another suitable conductive material, or a combination thereof. Additionally, or alternatively, conductive layer 128 can comprise a single layer or a plurality of layers, some or all of which can be conductive. In some embodiments, conductive layer 128 defines the electrode network 190, so as to define the common electrode 124 and/or driving electrode 126.

Following application of conductive layer 128 to intermediate layer 118, the conductive layer can be segmented into various conductive elements (e.g., common electrode 124, common electrode segments 124A-D, driving electrode 126, driving electrode segments 126A-D, and/or other electrical devices).

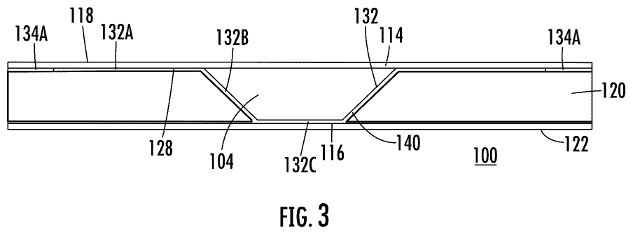

As shown in FIG. 3, a lens 100 according to at least one embodiment includes intermediate layer 120 in which cavity 104 is formed. The cavity 104 is positioned so as to be between first window 114 and second window 116. First window 114 is a portion of a first outer layer 118, and second window 116 is a portion of second outer layer 122. A portion of conductive layer 128 is disposed between the intermediate layer 120 and second outer layer 122.

In some embodiments, liquid lens 100 comprises an insulating layer 132 disposed within cavity 104. For example, insulating layer 132 comprises an insulating coating applied to intermediate layer 120. Insulating layer 132 can comprise polytetrafluoroethylene (PTFE), parylene, another suitable polymeric or non-polymeric insulating material, or a combination thereof. Additionally, or alternatively, insulating layer 132 comprises a hydrophobic material. Additionally, or alternatively, insulating layer 132 can comprise a single layer or a plurality of layers, some or all of which can be insulating.

In some embodiments, insulating layer 132 is provided on a sidewall 140 of the cavity 104. First outer layer 118 can be bonded to intermediate layer 120 at a bond 134A. In some embodiments, no gap or clearance is present between the bond 134A and the insulating layer 132, as shown in FIG. 3. Furthermore, in some embodiments, outer layer 118 is directly bonded to the insulating layer 132. The direct bonding of the outer layer 118 to the insulating layer 132 avoids the need to perform post-processing and/or removal of the insulating layer 132. Further, there is no need to clear or separate the insulating layer 132 from the surface of the bond 134. Moreover, the direct bonding ensures that there is no exposure of the layers underneath the insulating layer 132 to the polar liquid 106.

Moreover, in some embodiments, there is no gap or clearance between the first upper layer 118 and the insulating layer 132, which in turn directly contacts the conductive layer 128 without a gap therebetween. Further, in some embodiments in which the conductive layer 128 includes an electrode network 190 having a common electrode 124 and at least one driving electrode 126, an insulating layer 132 is disposed continuously on top of the conductive layer 128 until it reaches the contact pad (e.g., contact pad 150A, 150B) used to protect the lens from the exterior. In some embodiments, there may be a gap between the insulating layer 132 and the bond 134. Accordingly, no recess is needed to enable contact between first liquid 106 and an exposed portion (e.g., an exposed segment) of the common electrode 124, because the common electrode 124 is insulated from the liquids 106, 108, as are the driving electrodes 126A-D.

In some embodiments, insulating layer 132 may include a first insulating layer portion 132A disposed between the first window 114 (or the first outer layer 118) and a first portion of the driving electrode 126, a second insulating layer portion 132B disposed between the cavity 104 and the conductive layer 128 at the sidewall 140, and a third insulating layer portion 132C disposed between the cavity and the second window 116 (or the second outer layer 122). For example, the second insulating layer portion 132B can be disposed on the sidewall 140 to isolate the conductive layer 128 from each of the first liquid 106 and the second liquid 108 and/or to insulate interdigitated electrode portions from each other. Additionally, or alternatively, the third insulating layer portion 132C can be disposed on an interior surface of the second window 116.

In some embodiments, insulating layer 132 comprises a hydrophobic surface layer of cavity 104. Such a hydrophobic surface layer can help to maintain first liquid 106 and second liquid 108 within cavity 104 (e.g., by attraction between the non-polar second liquid and the hydrophobic material). The insulating layer 132 may be a dielectric film having sufficient elasticity to accommodate dimensional variations of a substrate (e.g. substrate 118, 120, or 122). Further, the insulating layer 132 may have a hydrophobic top surface, e.g., due to the presence of a hydrophobic top layer coating or due to the intrinsic bulk material properties of the insulating layer 132.

Furthermore, the insulating layer 132 may be sufficiently thin to permit the lens 100 to be sealed by bonding. Such direct bonding to close the lens body 102 of lens 100 avoids the masking, partial removal, and unmasking operations associated with closing some liquid lenses. In particular, in some embodiments, the first layer 118 may be bonded to the intermediate layer 120, for example, without first stripping a portion of the insulating layer 132 off of the intermediate layer (e.g., to expose the underlying conductive layer 128).

In some embodiments, driving electrode 126 comprises a plurality of driving electrode segments. For example, in some embodiments, as shown in FIG. 2B, driving electrode 126 comprises a first driving electrode segment 126A, a second driving electrode segment 126B, a third driving electrode segment 126C, and a fourth driving electrode segment 126D. In some embodiments, the driving electrode segments are distributed substantially uniformly about the sidewall of cavity 104. For example, each driving electrode segment occupies about one quarter, or one quadrant, of the sidewall of cavity 104.

Driving electrode 126 is described herein as being divided into four driving electrode segments in some illustrative examples. For example, as shown in FIG. 2B, four driving electrode segments 126A, 126B, 126C and 126D are provided. A common electrode 124 is connected on four perpendicular axes so as to be distributed among a first segment 124A, a second segment 124B, a third segment 124C and a fourth segment 124D. In some of such embodiments, each of the four driving electrode segments comprises a plurality of fingers that are interdigitated with a plurality of fingers of the corresponding one of the four common electrode segments. However, other embodiments are encompassed by this disclosure. In some embodiments, the driving electrode comprises a single driving electrode (e.g., substantially circumscribing the sidewall of the cavity). For example, the liquid lens comprising such a single driving electrode can be capable of varying focal length, but incapable of tilting the interface (e.g., an autofocus only liquid lens). In some other embodiments, the driving electrode is divided into two, three, five, six, seven, eight, or more driving electrode segments (e.g., distributed substantially uniformly about the sidewall of the cavity). In some embodiments, the locations of the common electrode and driving electrodes may be reversed.

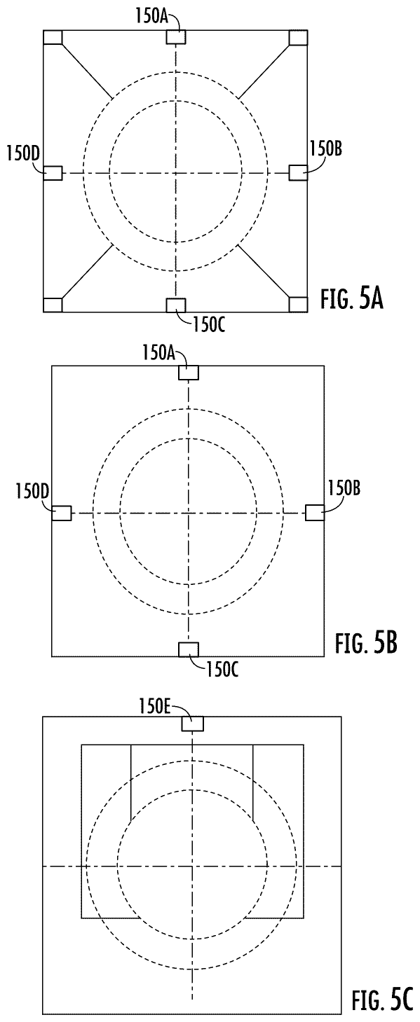

The driving electrode segments 126A, 126B, 126C, 126D may each be connected to a contact pad to facilitate electrical connection to the driving electrode 126. The connection scheme may be varied to accommodate specific layout considerations or particular applications. FIG. 5A is a top view of a liquid lens according to at least one embodiment. In some embodiments, as shown in FIG. 5A, four connecting pads 150A, 150B, 150C and 150D are disposed on an upper side of the liquid lens (e.g., a side where layer 114 shown in FIG. 3 is disposed). Contact pads 150A, 150B, 150C and 150D respectively connect to driving electrode segments 126A, 126B, 126C and 126D.

FIG. 5B is a top view of a liquid lens according to another embodiment. In some embodiments, as shown in FIG. 5B, the contact pads to the common electrode 124 are placed on the bottom of the lens. As with FIG. 5A, contact pads 150A, 150B, 150C and 150D are respectively connected to driving electrode segments 126A, 126B, 126C and 126D. The implementation shown in FIG. 5A may be advantageous for an integration where all the connecting pads are on the same side of the lens. The implementation shown in FIG. 5B may be advantageous for an integration where the smaller number of connecting pads is desired. FIG. 5C is a bottom view of a liquid lens according to yet another embodiment. In contrast to FIGS. 5A and 5B, in some embodiments, as shown in FIG. 5C, a contact pad 150E connects to the common electrode 124 (e.g., each of common electrode segments 124A, 124B, 124C, and 124D). In some embodiments, multiple contact pads (e.g., between 4-8 contact pads) may be present to connect the driving and common electrode segments.

FIG. 3 depicts a liquid lens according to some embodiments. The insulating layer 132 shown in FIG. 3 may be a single layer structure or a multi-layer structure including, for example, an insulating material to which a coating may be bonded. The insulating material may be SiO2, for example. In some embodiments, a thin hydrophobic coating may be provided having a thickness between 50 nm and 500 nm, and, in particular, between 50 nm to 200 nm. The hydrophobic coating may be in the form of a topcoat provided with the insulating material and either stripped off or retained, in accordance with some embodiments. Further still, not only may the insulating layer 132 be a single layer structure, but in some embodiments, the insulating layer 132 (regardless of whether it is a single or multi-layer structure) may be the only such insulating layer present in the lens 100.

Various embodiments of dielectrowetting-based liquid lenses described herein exhibit benefits. Such benefits include the avoidance of saturation and allow for the contact angle where one or more dielectric liquids contact an insulating layer to be varied from a contact angle with no voltage applied (e.g., between about 15° to about 30°, or) 26° up to about 170°, or more than 170°, e.g., up to about 180°. Thus, as compared to electrowetting-based liquid lenses, certain embodiments achieve a larger optical power output with respect to the applied voltage.

Further, as described above, none of the liquids is in contact with any electrode. The insulating layer is placed between the electrode array and the liquids. The insulating layer may be made of a parylene layer, a thin SiO₂ layer, and a topcoat, or a thin Si₃N₄ layer and a top coat, or combinations thereof. In some embodiments, the total thickness of the insulating stack is between 50 nm and 5 microns. In other embodiments, the total thickness is between 50 nm and 1 micron. In yet other embodiments, the total thickness is between 50 nm and 500 nm. The electric field is developed through the electrode network 124 and 126, but not between the electrodes and the liquids. Thus, a very thin dielectric layer may be used on top of the electrodes without a significant breakdown risk, provided the interelectrode gap is large enough.

By virtue of the insulating layer, the electrodes are completely protected from chemical interaction with the liquids due to a physical barrier (e.g., a dielectric layer or coating), thereby preventing water treeing breakdown. As there is no contact between the liquids, which may contain additives and/or ions to which the conductive layer and/or glass portions of the lens would otherwise be exposed, such embodiments may have a longer service life due to the reduction in degradation of these portions of the liquid lens.

By choosing the inclination angle of the inclined side wall, the dielectrowetting liquid lens can be designed such that the optical power range of the lens is centered around a contact angle value of the liquid/liquid interface on the hydrophobic surface of about 90°. It has been observed that having this contact angle close to 90° can help to reduce the response time of the liquid lens, for example, as a result of force balance and trigonometrical calculations. Thus, a flat liquid lens without an inclined side wall would be expected to have a larger response time.

### Liquid Lens Manufacturing

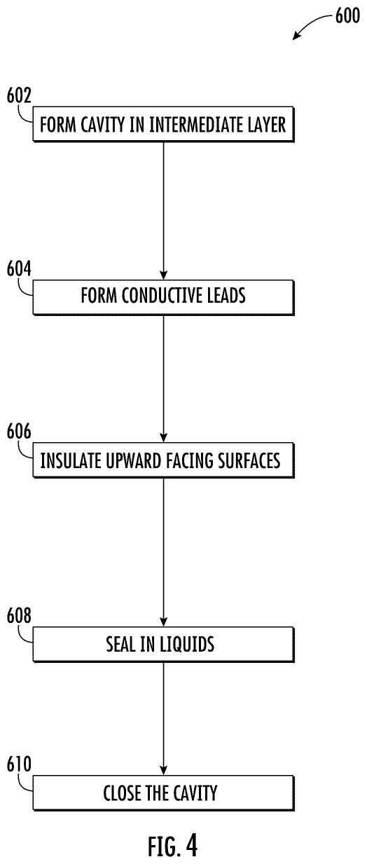

FIG. 4 depicts a method 600 of making a liquid lens in accordance with at least one embodiment. First, the cavity 104 with the conical shape is formed in the intermediate layer 120 (602). This cavity can be formed using molten glass forming technology, injection molding when the intermediate layer is plastic or ceramic, or via laser forming, or machine turning in some embodiments. In some embodiments, the intermediate layer 120 is glass and is formed with glass hot forming or glass laser forming technology. In other embodiments, the intermediate layer 120 is metal and shaped with diamond tool turning. In some of such embodiments, an insulating layer is placed on top of the metallic layer 120, whereby the insulating layer is disposed between the conducting material of the intermediate layer and the conducting leads described below (e.g., to prevent shorting).

Once the intermediate layer has been shaped with a conical cavity 104 and has been manufactured, the conducting leads forming the interdigitated electrode network and the connections to the connecting pads are formed (604). In some embodiments, such process comprises forming conducting layer 128 and patterning the conducting layer to form the electrodes. In some embodiments, sputtering in vacuum is used for the deposition. In other embodiments, metal evaporation and condensation is used. For such techniques, masking may be used to provide the final shape to the electrode network 190.

After the cone forming step and the conductive layer deposition, the hydrophobic insulating layer 132 is placed on top of all the upward facing surfaces (606). A variety of techniques can be used to prepare hydrophobic insulation layers, including, for example, CVD, PECVD, sputtering, ion beam sputtering, or atomic layer deposition, among others.

The insulating layer 132 isolates the liquid 106, 108 stored in the cavity 104 by establishing an impermeable barrier. In some embodiments, the insulating layer 132 is the only barrier between the sidewall 140 of the cavity and one or more electrodes. The insulating layer 132 may be deposited using gas phase techniques such as chemical vapor deposition, plasma vapor deposition, sputtering, atomic layer deposition, or plasma-enhanced chemical vapor deposition.

Further, in some embodiments, the method may further include depositing immiscible liquids in the hydrophobically coated cavity, e.g., by introducing first liquid 106 and second liquid 108 into the cavity 104 (e.g., with a micro-syringe) and then hermetically sealing the liquids in the cavity (608). For example, electrodes may be formed on at least a sidewall of the cavity 104, e.g., on an opposite side of the insulating layer 132 from the liquids 106, 108. In some embodiments, the interdigitated electrode array may be constructed by depositing a metallic layer on a substrate (e.g., a polyimide substrate), applying photoresist, placing a mask on the photoresist, transferring the mask, depositing copper via electroplating, removing the photoresist, removing the metallic layer, depositing a further metallic layer (e.g., a tin layer) on the copper by electroplating, and excising residual substrate. In some embodiments, the electrode network 190 formed by the interdigitated electrode array may be deposited on the insulating layer 132 by high resolution printing or vapor phase deposition using a mask.

The intermediate layer 120 is bonded to the outer layer (bottom window) 122, so as to close the bottom of the cavity 104 (610). In some embodiments, layers 116 and 120 may be sealed with laser beam technology (e.g., applying laser energy in the form of a beam). In some other embodiments, layers 116 and 122 may be glued. The top of the cavity (at upper window 114) may remain open, e.g., for the purpose of applying the hydrophobic insulating layer 132 and depositing liquids 106, 108 in the cavity 104.

In at least one embodiment, the method 600 may further include connecting the electrodes of electrode network 190 to contacts to enable electrical connection of liquid lens 100 to a controller, a driver, or another component of a lens or camera system.

While this specification contains specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The terms “attached,” “coupled,” “connected,” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

It is important to note that the construction and arrangement of the system shown in the various example implementations are illustrative only and not restrictive in character. All changes and modifications that come within the spirit and/or scope of the described implementations are desired to be protected. It should be understood that some features may not be necessary and implementations lacking the various features may be contemplated as within the scope of the application, the scope being defined by the claims that follow. When the language “a portion” is used the item can include a portion and/or the entire item unless specifically stated to the contrary.

1. A liquid lens, comprising:
a cavity;
a first liquid disposed in the cavity;
a second liquid disposed in the cavity, the first liquid differing from the second liquid, wherein a variable interface is defined between the first liquid and the second liquid;
an interdigitated array of electrode segments comprising a plurality of driving electrode segments interdigitated with a plurality of common electrode segments disposed on an inclined sidewall portion of the cavity; and
an insulating layer isolating each of the plurality of common electrode segments and the plurality of driving electrode segments from both the first liquid and the second liquid;
wherein the interface between the first liquid and the second liquid is adjustable to change a focus of the liquid lens by adjusting an electrical signal applied to the interdigitated array of electrode segments.

2. The liquid lens of claim 1, further comprising:
a first window; and
a second window,
wherein the cavity is disposed between the first window and the second window, and
wherein the cavity is frustoconical.

3. The liquid lens of claim 1, wherein the first liquid and the second liquid are dielectric liquids differing in dielectric constant.

4. The liquid lens of claim 1, wherein the inclined sidewall portion of the cavity is coated with a hydrophobic coating.

5. The liquid lens of claim 4, wherein the hydrophobic coating is a topcoat disposed on the insulating layer.

6. The liquid lens of claim 1, wherein the insulating layer is disposed in the cavity.

7. The liquid lens of claim 1, wherein the interdigitated array of electrode segments comprises microelectrodes in a concentric circular distribution on the the inclined sidewall portion of the cavity.

8. The liquid lens of claim 1, wherein the at least one array comprises microelectrodes in a radial distribution on the inclined sidewall portion of the cavity.

9. The liquid lens of claim 1, wherein at least two of the plurality of common electrode segments are electrically coupled to be driven by a common electrical signal.

10. The liquid lens of claim 9, wherein at least two of the plurality of driving electrode segments are electrically coupled to be driven by a driving electrical signal that is different than the common electrical signal.

11. A method of making a liquid lens, comprising:
depositing a plurality of microelectrodes in an array on a sidewall portion of a cavity of a lens body, the sidewall portion of the cavity inclined such that a cross-sectional area of the cavity decreases in a direction from an object side of the lens body toward an image side of the lens body, the plurality of microelectrodes comprising a plurality of driving electrode segments interdigitated with a plurality of common electrode segments;
depositing an insulating layer on at least one of the driving electrode segments; and
depositing a first liquid and a second liquid in the cavity, the insulating layer isolating the microelectrodes from each of the first liquid and the second liquid.

12. The method of claim 11, wherein the insulating layer comprises parylene, SiO₂, or Si₃N₄.

13. The method of claim 11, comprising forming the array of microelectrodes as a concentric circular array.

14. The method of claim 11, comprising forming the array of microelectrodes as a radial array.

15. The method of claim 11, wherein:
the cavity is disposed between a first window and a second window, and
the insulating layer is disposed between a portion of at least one of the driving electrode segments and the first window, without a clearance therebetween.

16. The method of claim 11, wherein a shape of an interface between the first liquid and the second liquid is adjustable responsive to a voltage between at least one of the common electrode segments and at least one of the driving electrode segments.

17. A liquid lens, comprising:
a cavity disposed between a first window and a second window;
an interdigitated array of electrodes comprising at least one first electrode and at least one second electrode disposed on an inclined sidewall portion of the cavity;
an insulating layer isolating each of the at least one first electrode and the at least one second electrode from a liquid disposed within the cavity; and
electrode leads for the interdigitated array of electrodes disposed on only one of a first surface of the liquid lens above the cavity or a second surface of the liquid lens below the cavity.

18. The liquid lens of claim 17, wherein the inclined sidewall portion of the cavity is frustoconical.

19. The liquid lens of claim 18, wherein a surface of the inclined sidewall portion of the cavity is opaque, and wherein the first window and the second window are transparent.

20. The liquid lens of claim 18, wherein the insulating layer forms a barrier between the liquid and the at least one second electrode.
